(19) United States
(12) Patent Application Publication
(10) Pub. No.: US 2015/0215255 A1
(43) Pub. Date: Jul. 30, 2015

(54) Method and device for sending microblog message

(71) Applicant: TENCENT TECHNOLOGY (SHENZHEN) COMPANY LIMITED, Shenzhen, Guangdong (CN)

(72) Inventors: Huan Xiong, Shenzhen (CN); Jun Shu, Shenzhen (CN)

(73) Assignee: TENCENT TECHNOLOGY (SHENZHEN) COMPANY LIMITED, Shenzhen, Guangdong (CN)

(21) Appl. No.: 14/125,894

(22) PCT Filed: Mar. 1, 2013
(86) PCT No.: PCT/CN2013/072083

§ 371 Date: Dec. 12, 2013

(30) Foreign Application Priority Data
Mar. 1, 2012 (CN) 201210051607.3

(51) Int. Cl. H04L 12/58; H04L 29/08; H04L 12/24

(52) U.S. Cl. CPC H04L 51/16; H04L 41/06; H04L 67/26

(57) ABSTRACT

Disclosed is a method for sending a microblog message, including that: when a new microblog message is received, a microgroup identification (ID) mentioned in the microblog message is acquired; and when a user sending the microblog message has been enrolled in a microgroup corresponding to the microgroup ID, the microblog message is sent to all member users in the microgroup. The present disclosure further provides a device for mentioning a number of people in the field of microblog. According to a technical solution of the present disclosure, it is possible to mention a number of people in a microgroup in the field of microblog.

### TECHNICAL FIELD

The present disclosure relates to the field of microblog on the Internet, and in particular to a method and device for sending a microblog message.

### BACKGROUND

A microblog message may be sent to a list of to-be-received messages of a microblog user ID generally by attaching the user ID to a symbol @ in the microblog message. Such an action is called mentioning. The so-called mentioning, similar to a CC (carbon-copy) function in a mail, is generally used to CC a microblog message directly into a list of “messages mentioning me” in the microblog of a designated friend, such that the designated friend may explicitly receive a reminder, and directly see the microblog message in the list of “messages mentioning me”. In addition, there is another operation that enrolls a number of people in a group similar to an Instant Messaging (IM) group, which group is administrated and uniquely identified through a group number. Such a group is called a microgroup in a microblog.

As shown in FIG. 1, in the relevant art, if it is desired to mention a number of people in a microblog message, a number of @xxx have to be input consecutively when the microblog message is sent in order to send the microblog message simultaneously to a number of microblog friends desired to be mentioned. Therefore, it is inconvenient to operate with an existing method for mentioning a number of people, as user IDs of a lot of microblog friends have to be memorized and input. In addition, as a microblog message has a length limited to 140 words including an input user ID of a mentioned microblog friend, the number of friends that can be mentioned in a single microblog message is thus limited.

### SUMMARY

In view of this, the main objective of the present disclosure is to provide a method and device for sending a microblog message, it is possible to mention a number of people in a microgroup in the microblog.

To achieve the objective, a technical solution of the present disclosure is implemented as follows.

The present disclosure provides a method for sending a microblog message, including:

when a new microblog message is received, a microgroup ID mentioned in the microblog message is acquired; and

when a user sending the microblog message has been enrolled in a microgroup corresponding to the microgroup ID, the microblog message is sent to all member users in the microgroup.

In the method, the step that a microgroup ID mentioned in the microblog message is acquired may be:

a microblog type or microblog name mentioned in the microblog message is extracted, and the microgroup ID corresponding to the microblog type or microblog name is acquired according to the microblog type or microblog name.

In the method, the step that a microblog type or microblog name mentioned in the microblog message is extracted may be:

the new microblog message is searched for a fixed symbol, and content attached to the fixed symbol are taken as the microblog type or microblog name.

The method may further include:

when there are identical microgroup types or identical microgroup names, a number of microgroup IDs corresponding to the identical microgroup types or identical microgroup names are acquired;

it is determined whether there is at least one common microgroup ID in microgroup IDs of all microgroups the user sending the microblog message is enrolled in and in the acquired microgroup IDs; and

if there is at least one common microgroup ID, then it is determined that the microgroup corresponding to the common microgroup ID is the microgroup mentioned in the microblog message; and if there is none, then the user sending the microblog message is promoted that there is an error in sending the message.

The method may further include: before the microblog message is sent to all member users in the microgroup, it is determined whether the user sending the microblog message has been enrolled in the microgroup corresponding to the microgroup ID; and

when it is determined that the user sending the microblog message has not been enrolled in the microgroup corresponding to the microgroup ID, the user is promoted that the microblog message fails to be sent;

when it is determined that the user sending the microblog message has been enrolled in the microgroup corresponding to the microgroup ID, the microblog message is sent to all member users in the microgroup.

In the method, the step that the microblog message is sent to all member users in the microgroup may be:

it is determined, in all member users of the microgroup, whether there is at least one member user who follows the user sending the microblog message; and

if there is, then the microblog message is sent to the remaining member user/users in the microgroup other than the member user who follows the user sending the microblog message; and if there is none, then the microblog message is sent to all member users in the microgroup.

The present disclosure further provides a device for sending a microblog message, including an acquiring module, a determining module, and a sending module,

wherein the acquiring module is configured to, when a new microblog message is received, acquire a microgroup ID mentioned in the microblog message;

wherein the determining module is configured to determine whether a user sending the microblog message has been enrolled in a microgroup corresponding to the microgroup ID;

wherein the sending module is configured to, when the determining module determines that the user sending the microblog message has been enrolled in the microgroup corresponding to the microgroup ID, send the microblog message to all member users in the microgroup.

The device may further include:

a prompting module configured to, when the determining module determines that the user sending the microblog message has not been enrolled in the microgroup corresponding to the microgroup ID, prompt the user that the microblog message fails to be sent.

In the method,

the acquiring module may be configured to acquire the microgroup ID mentioned in the microblog message by extracting a microblog type or microblog name mentioned in the microblog message and acquiring the microgroup ID corresponding to the microblog type or microblog name according to the microblog type or microblog name; and

the acquiring module may be configured to extract the microblog type or microblog name mentioned in the microblog message by searching the new microblog message for a fixed symbol and taking content attached to the fixed symbol as the microblog type or microblog name.

In the method, the sending module may be configured to send the microblog message to all member users in the microgroup by

determining, in all member users of the microgroup, whether there is at least one member user who follows the user sending the microblog message; and

if there is, then pushing the microblog message to the remaining member user/users in the microgroup other than the member user who follows the user sending the microblog message; and if there is none, then pushing the microblog message to all member users in the microgroup.

With the method and device for sending a microblog message provided by the present disclosure, when a new microblog message is received, a microgroup ID mentioned in the microblog message is acquired; and when a user sending the microblog message has been enrolled in a microgroup corresponding to the microgroup ID, the microblog message is sent to all member users in the microgroup. Therefore, with the present disclosure, it is possible to mention, in the field of microblog, a number of people contained in a microgroup by mentioning a microgroup, and thus to send the microblog message to a number of users contained in the microgroup by mentioning the microgroup. The operation in the present disclosure is simple and easy, and words included in the microblog message can be saved, such that the microblog message can be sent to more users simultaneously.

### BRIEF DESCRIPTION OF THE DRAWINGS

FIG. 1 is a diagram of an example of mentioning a number of people in a microblog message in the relevant art;

FIG. 2 is a flowchart of a method for sending a microblog message according to an embodiment of the present disclosure;

FIG. 3 is a diagram of an example of mentioning a microgroup in a microblog message according to an embodiment of the present disclosure; and

FIG. 4 is a schematic diagram of a structure of a device for sending a microblog message according to an embodiment of the present disclosure.

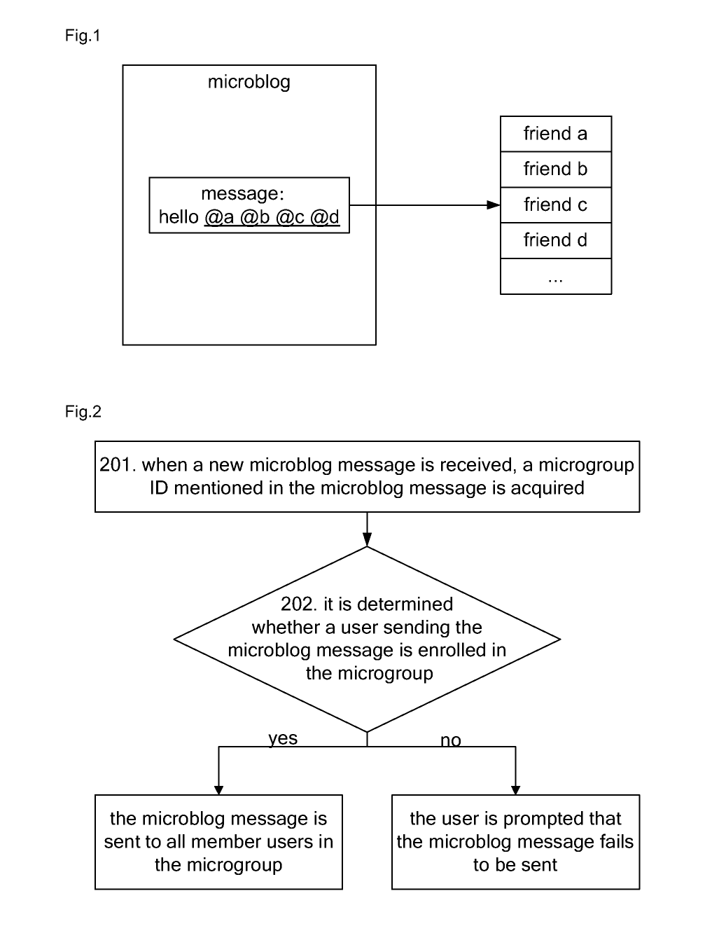

### DETAILED DESCRIPTION

According to various embodiments of the present disclosure, when a new microblog message is received, a microgroup identification (ID) mentioned in the microblog message is acquired; and when a user sending the microblog message has already been enrolled in a microgroup corresponding to the microgroup ID, the microblog message is sent to all member users in the microgroup.

The present disclosure is further elaborated below with reference to the drawings and embodiments.

An embodiment of the present disclosure provides a method for sending a microblog message. FIG. 2 is a flowchart of a method for sending a microblog message according to an embodiment of the present disclosure. As shown in FIG. 2, the method includes the following steps.

step 201, when a new microblog message is received, a microgroup ID mentioned in the microblog message is acquired.

Specifically, when a new microblog message is received, a microblog type or microblog name mentioned in the microblog message is extracted, and then the microgroup ID corresponding to the microblog type or the microblog name according to the microblog type or microblog name is acquired.

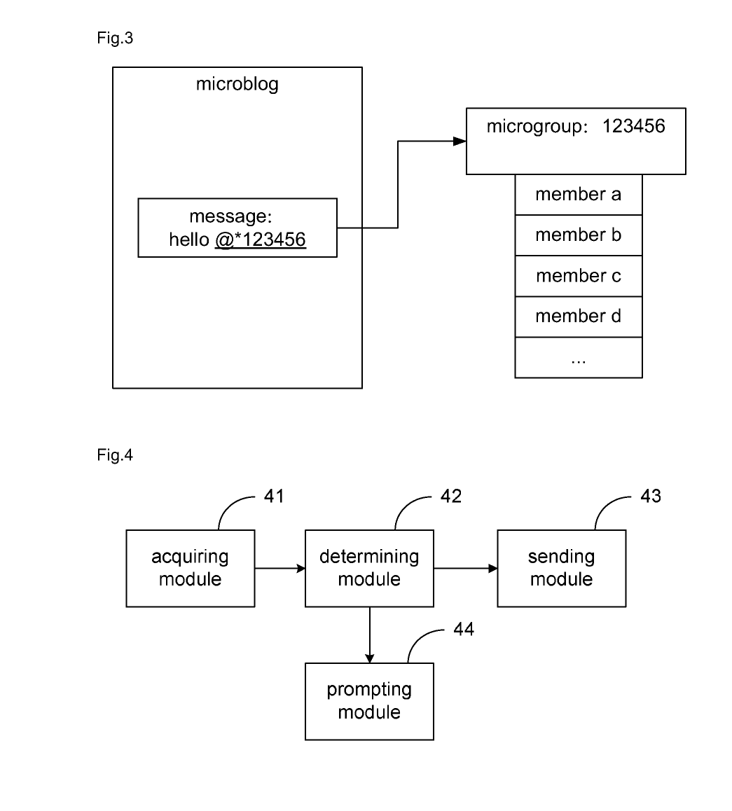

In the embodiments of the present disclosure, the new microblog message may be searched for a fixed symbol, such as @*, #, #*, and the like. The content attached to the fixed symbol is the microblog type or microblog name. To this end, a rule may be preset to define a few fixed symbols which are easy to be input on various microblog clients, easy to be memorized, compatible with an existing customary way of mentioning, easy to be distinguished and understood, and the like. For example, “@*” may serve as a prefix for mentioning a microgroup. @ has already been commonly used in the microblog as a way of mentioning. “@*” may be input directly on a microblog terminal. “@*” itself is kind of a wildcard, namely, it stands for a batch of similar things. Therefore, a natural understanding of use of @* is to mention a microgroup. As shown in FIG. 3, when a microgroup name is attached to “@*” to specify a microgroup, it amounts to mentioning all member users in the microgroup. Thus, instead of mentioning a member user, all member users in the microgroup is mentioned in the microblog message. Thus, after a newly written microblog message is received, it is determined whether there is any word “@*xxx” in the microblog message according to the set rule defining the symbols for mentioning a microgroup. If there is none, which means that the microblog message does not mention any microgroup, then the microblog message is issued directly. If there is a word “@*xxx”, and it may be determined, according to the rule defining the symbols for mentioning a microgroup, that the microblog message mentions a certain microgroup, then the content of the word “@*xxx” is extracted, and a mentioned microgroup ID is determined according to the part xxx thereof, wherein xxx represents a microgroup type or microgroup name.

If there are identical microgroup types or identical microgroup names, a number of microgroup IDs corresponding to the microgroup types or microgroup names may be acquired. In the embodiments of the present disclosure, it may be determined whether there is at least one common microgroup ID in microgroup IDs of all microgroups the user sending the microblog message is enrolled in and in the acquired microgroup IDs. If there is at least one common microgroup ID, then it is determined that the microgroup corresponding to the common microgroup ID is the microgroup mentioned by the microblog message. If there is none, then the user sending the microblog message may be prompted that there is an error in sending the message.

step 202, it is determined whether a user sending the microblog message is enrolled in the microgroup. If the user is enrolled as a member, the microblog message is sent to all member users in the microgroup. If the user is not enrolled as a member, the user is promoted that the microblog message fails to be sent.

Specifically, only a member user in the microgroup can mention the whole microgroup. Therefore when the microblog message is received, it is required to determine whether the user sending the microblog message is enrolled in the microgroup corresponding to the acquired microgroup ID, that is, to determine whether the user is a member user of the microgroup.

if the user is a member user of the microgroup, it is required to further determine, in all member users in the microgroup, whether there is at least one member user who follows the user sending the microblog message. If there is, then the microblog message may not be pushed to member users who follow the user sending the microblog message, so as to avoid receiving the microblog message repeatedly by the member users and occupying network resources, since the user sending the microblog message is already followed of these member users. All these member users can receive each microblog message sent by the user, and do not need to receive the microblog message once again as a member user of the microgroup. Therefore the microblog message is pushed to the remaining member user/users in the microgroup. If there is, in all member users in the microgroup, no member user following the user sending the microblog message, then the microblog message is pushed to all member users in the microgroup. As thus, a member user of the microgroup may receive a reminder for arrival of a new message on a microblog interface and on a page card interface of the microgroup, or may interact directly with the sender of the microblog message on the microblog message.

If the user is not a member user of the microgroup, then the user may be prompted that he/she cannot send the microblog message and the microblog message fails to be sent, or may be further asked to confirm whether he/she is enrolled in the microgroup.

To implement the method, an embodiment of the present disclosure further provides a device for sending a microblog message. FIG. 4 is a schematic diagram of a structure of a device for sending a microblog message according to an embodiment of the present disclosure. As shown in FIG. 4, the device mainly includes an acquiring module 41, a determining module 42 and a sending module 43.

The acquiring module 41 is configured to, when a new microblog message is received, acquire a microgroup ID mentioned in the microblog message.

The determining module 42 is configured to determine whether a user sending the microblog message has been enrolled in a microgroup corresponding to the microgroup ID.

The sending module 43 is configured to, when the determining module 42 determines that the user sending the microblog message has been enrolled in the microgroup corresponding to the microgroup ID, send the microblog message to all member users in the microgroup.

Preferably, the device may further include:

a prompting module 44 configured to, when the determining module 42 determines that the user sending the microblog message is has not been enrolled in the microgroup corresponding to the microgroup ID, prompt the user that the microblog message fails to be sent.

In some examples, the acquiring module 41 is configured to acquire the microgroup ID mentioned in the microblog message by extracting a microblog type or microblog name mentioned in the microblog message and acquiring the microgroup ID corresponding to the microblog type or microblog name according to the microblog type or microblog name.

In some examples, the acquiring module 41 is configured to extract the microblog type or microblog name mentioned in the microblog message by searching the new microblog message for a fixed symbol and taking content attached to the fixed symbol as the microblog type or microblog name.

The sending module 43 may be configured to send the microblog message to all member users in the microgroup by

determining, in all member users of the microgroup, whether there is at least one member user who follows the user sending the microblog message; and

if there is, then pushing the microblog message to the remaining member user/users in the microgroup other than the member user who follows the user sending the microblog message; and if there is none, then pushing the microblog message to all member users in the microgroup.

What described are merely preferred embodiments of the disclosure, and are not intended to limit the scope of the present disclosure. Any modification, equivalent replacement, improvement, and the like made within the principle of the present disclosure should be included in the scope of the present disclosure.

1. A method for sending a microblog message, comprising:
when a new microblog message is received, acquiring a microgroup ID mentioned in the microblog message; and
when a user sending the microblog message has been enrolled in a microgroup corresponding to the microgroup ID, sending the microblog message to all member users in the microgroup.

2. The method according to claim 1, wherein the acquiring a microgroup ID mentioned in the microblog message is:
extracting a microblog type or microblog name mentioned in the microblog message, and acquiring the microgroup ID corresponding to the microblog type or microblog name according to the microblog type or microblog name.

3. The method according to claim 2, wherein the extracting a microblog type or microblog name mentioned in the microblog message is:
searching the new microblog message for a fixed symbol, and taking content attached to the fixed symbol as the microblog type or microblog name.

4. The method according to claim 2, further comprising:
when there are identical microgroup types or identical microgroup names, acquiring a number of microgroup IDs corresponding to the identical microgroup types or identical microgroup names;
determining whether there is at least one common microgroup ID between microgroup IDs of all microgroups the user sending the microblog message is enrolled in and the acquired microgroup IDs; and
in the case there is at least one common microgroup ID, then determing that the microgroup corresponding to the common microgroup ID is the microgroup mentioned in the microblog message; and in the case there is none, then prompting the user sending the microblog message that there is an error in sending the message.

5. The method according to claim 1, further comprising: before sending the microblog message to all member users in the microgroup, determining whether the user sending the microblog message has been enrolled in the microgroup corresponding to the microgroup ID;
when it is determined that the user sending the microblog message has not been enrolled in the microgroup corresponding to the microgroup ID, prompting the user that the microblog message fails to be sent;
when it is determined that the user sending the microblog message has been enrolled in the microgroup corresponding to the microgroup ID, sending the microblog message to all member users in the microgroup.

6. The method according to claim 1, wherein the sending the microblog message to all member users in the microgroup is:
determining, in all member users of the microgroup, whether there is at least one member user who follows the user sending the microblog message; and
if there is, then pushing the microblog message to the remaining member user/users in the microgroup other than the member user who follows the user sending the microblog message; and if there is none, then pushing the microblog message to all member users in the microgroup.

7. A device for sending a microblog message, comprising:
an acquiring module configured to, when a new microblog message is received, acquire a microgroup ID mentioned in the microblog message;
a determining module configured to determine whether a user sending the microblog message has been enrolled in a microgroup corresponding to the microgroup ID; and
a sending module configured to, when the determining module determines that the user sending the microblog message has been enrolled in the microgroup corresponding to the microgroup ID, send the microblog message to all member users in the microgroup.

8. The device according to claim 7, further comprising:
a prompting module configured to, when the determining module determines that the user sending the microblog message has not been enrolled in the microgroup corresponding to the microgroup ID, prompt the user that the microblog message fails to be sent.

9. The device according to claim 7, wherein the acquiring module is configured to acquire the microgroup ID mentioned in the microblog message by extracting a microblog type or microblog name mentioned in the microblog message and acquiring the microgroup ID corresponding to the microblog type or microblog name according to the microblog type or microblog name; and
wherein the acquiring module is configured to extract the microblog type or microblog name mentioned in the microblog message by searching the new microblog message for a fixed symbol and taking content attached to the fixed symbol as the microblog type or microblog name.

10. The device according to claim 7, wherein the sending module is configured to send the microblog message to all member users in the microgroup by
determining, in all member users of the microgroup, whether there is at least one member user who follows the user sending the microblog message; and
if there is, then pushing the microblog message to the remaining member user/users in the microgroup other than the member user who follows the user sending the microblog message; and if there is none, then pushing the microblog message to all member users in the microgroup.

11. The method according to claim 3, further comprising:
when there are identical microgroup types or identical microgroup names, acquiring a number of microgroup IDs corresponding to the identical microgroup types or identical microgroup names;
determining whether there is at least one common microgroup ID between microgroup IDs of all microgroups the user sending the microblog message is enrolled in and the acquired microgroup IDs; and
in the case there is at least one common microgroup ID, then determing that the microgroup corresponding to the common microgroup ID is the microgroup mentioned in the microblog message; and in the case there is none, then prompting the user sending the microblog message that there is an error in sending the message.

12. The method according to claim 5, wherein the sending the microblog message to all member users in the microgroup is:
determining, in all member users of the microgroup, whether there is at least one member user who follows the user sending the microblog message; and
if there is, then pushing the microblog message to the remaining member user/users in the microgroup other than the member user who follows the user sending the microblog message; and if there is none, then pushing the microblog message to all member users in the microgroup.
